(19) United States
(12) Patent Application Publication
(10) Pub. No.: US 2005/0186849 A1
(43) Pub. Date: Aug. 25, 2005

(54) Convertible electrical connector

(76) Inventors: Yan Margulis, Buffalo Grove, IL (US); Steven B. Bogiel, Lisle, IL (US); Leroy Andrzejewski, Warrenville, IL (US); Arvind Patel, Naperville, IL (US)

Correspondence Address: MOLEX INCORPORATED, 2222 WELLINGTON COURT, LISLE, IL, 60532, US

(21) Appl. No.: 10/787,910

(22) Filed: Feb. 25, 2004

(51) Int. Cl. H01R 13/648

(52) U.S. Cl. 439/637

(57) ABSTRACT

An electrical connector is capable of easy conversion from a receptacle connector to a blade connector. A dielectric housing includes an elongated receptacle for receiving a blade terminal of an appropriate mating blade connector. At least one connector terminal is mounted on the housing and includes a contact portion exposed in the receptacle to form a receptacle connector and for engaging the blade terminal of the mating blade connector. A bare blade member has a mounting end fixable in the receptacle in engagement with the contact portion of the connector terminal. A bare blade end of the blade member projects from a mating face of the housing to convert the receptacle connector to a blade connector.

### FIELD OF THE INVENTION

This invention generally relates to the art of electrical connectors and, particularly, to an electrical connector assembly which can be converted from a receptacle or female connector to a male connector.

### BACKGROUND OF THE INVENTION

Generally, an electrical connector typically includes some form of dielectric housing which mounts one or more conductive terminals. The terminals typically have terminating ends exposed at a terminating face of the housing and contact ends located at a mating face of the housing. If the connector is a female or receptacle connector, the contact ends of the terminals are disposed within a receptacle or socket at the mating end of the housing. If the connector is a plug or male connector, the contact ends of the terminals project from the mating face of the housing. A female connector then is mateable with a complementary connecting device such as a second, mating male connector.

Electrical connectors of the character described above are used for a wide variety of applications. For instance, a pair of mating connectors may be used to couple electrical signal transmission lines, with the mating connectors transmitting electrical signals therethrough. Or, a pair of mating connectors may be “power” connectors to couple power lines and transmit electrical power through the mating connectors. Power connectors typically are rather robust structures, and a male power connector may include one or more rather sizable terminal blades.

Regardless of the connector configuration, a connector manufacturer typically must fabricate a given number of receptacle or female connectors in conjunction with their complementary mating plug or male connectors to form appropriate mating connector assemblies, as needed. This not only is true for manufacturers, but users of the connectors must maintain an inventory of both receptacle connectors and male connectors. High manufacturing costs as well as high inventory costs cause problems when a manufacturer must make different male and female connectors and a user must maintain different male and female connectors in inventory. The present invention is directed to solving these problems by providing a unique system wherein a female connector is very easily converted to a male connector without changing the connector housing in any way and without changing the interior terminals of the female connector.

### SUMMARY OF THE INVENTION

An object, therefore, of the invention is to provide an electrical connector assembly which is capable of easy conversion from a female or receptacle connector to a plug, blade or male connector.

In the exemplary embodiment of the invention, a dielectric housing includes a terminating face and a mating face which has an elongated receptacle for receiving a blade terminal of an appropriate mating blade connector. At least one connector terminal is mounted on the housing and includes a contact portion exposed in the receptacle to form a receptacle connector for engaging the blade terminal of the mating blade connector. A bare blade member has a mounting end fixable in the receptacle in engagement with the contact portion of the connector terminal. A bare blade end of the blade member projects from the mating face of the housing to convert the receptacle connector to a blade connector.

As disclosed herein, the contact portion of the connector terminal includes a plurality of contact spring fingers for engaging the blade terminal of the mating blade connector and for fixing to the blade member, as by soldering.

According to one aspect of the invention, the connector terminal includes a terminating portion exposed exteriorly of the housing. In the illustrated embodiment of the invention, the terminating face of the housing is a board-mounting face, and the terminating portion of the connector terminal comprises a plurality of tail portions for connection to appropriate circuit traces on a printed circuit board. The tail portions may comprise solder tails for insertion into appropriate holes in the printed circuit board.

According to another aspect of the invention, a plurality of connector terminals are mounted on the housing. Each connector terminal includes a contact portion exposed in the receptacle for engaging the blade terminal of the mating blade connector and, alternatively, for fixing to the bare blade member. A plurality of the connector terminals may be disposed on opposite sides of the receptacle. As disclosed herein, the receptacle is elongated and the plurality of connector terminals are spaced longitudinally of the receptacle along both opposite sides thereof. In any event, in the illustrated embodiment, the contact portion of each connector terminal includes a plurality of contact spring fingers for engaging the blade terminal of the mating blade connector and, alternatively, for fixing to the bare blade member.

Finally, with the receptacle being elongated, either a single bare blade member may be inserted into the receptacle and fixed to all of the plurality of connector terminals, or a plurality of the bare blade members may be inserted into the receptacle and fixed to respective ones of the plurality of connector terminals spaced longitudinally of the receptacle.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a female or receptacle connector according to the invention;

FIG. 2 is a perspective view of an appropriate, complementary mating blade or male connector which is mateable with the female connector of FIG. 1;

FIG. 3 is a top plan view of the receptacle connector of FIG. 1, looking at the mating face thereof;

FIG. 4 is a vertical section taken generally along line 4-4 of FIG. 3;

FIG. 5 is a side elevational view of one of the connector terminals;

FIG. 6 is a view similar to that of FIG. 4, but showing a section through the terminal-mounting slot in the housing for one of the terminals;

FIG. 7 is a bottom plan view of the receptacle connector;

FIG. 8 is a vertical section taken generally along line 8-8 of FIG. 4;

FIG. 9 is a perspective view of a bare blade member for converting the receptacle connector of FIGS. 1 and 3-5 to a blade connector;

FIG. 10 is a perspective view of a converted connector wherein the bare blade member of FIG. 9 has been fixed within the receptacle connector of FIGS. 1 and 3-8;

FIG. 11 is a vertical section taken generally along line 11-11 of FIG. 10, with the blade member in elevation;

FIG. 12 is a view similar to that of FIG. 9, but showing a plurality of bare blade terminals which are fixable within the receptacle connector of FIGS. 1 and 3-8; and

FIG. 13 is a perspective view of a converted connector similar to that of FIG. 10, but incorporating the plurality of blade members as shown in FIG. 12.

### DETAILED DESCRIPTION OF THE PREFERRED EMBODIMENTS

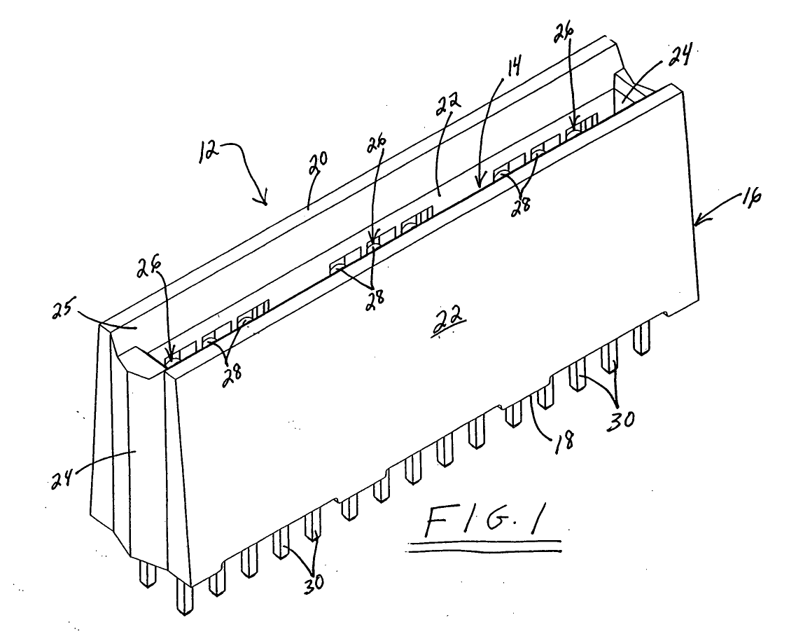

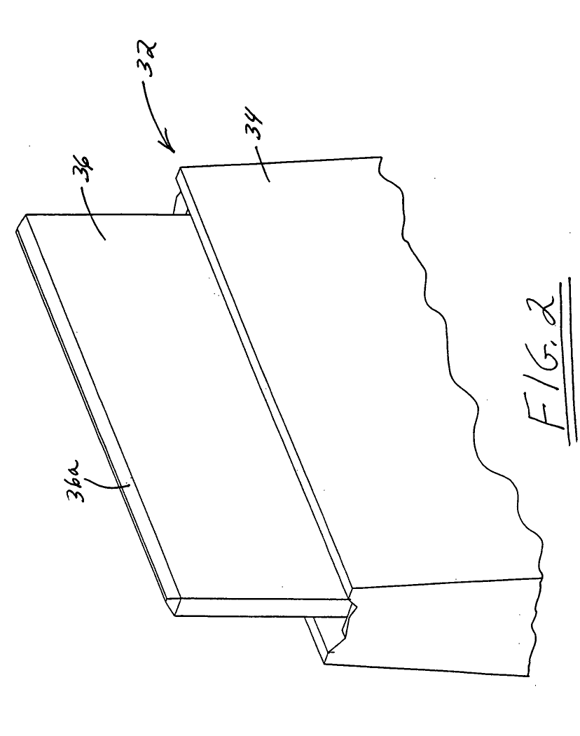

Referring to the drawings in greater detail, and first to FIG. 1, the invention is exemplified herein in conjunction with a receptacle connector, generally designated 12, which is a “power” connector in that it is designed primarily for transmitting electrical power therethrough. Generally, receptacle connector 12 is a female connector, in that the receptacle or female connector includes a receptacle or socket, generally designated 14, for receiving a male terminal of a complementary male connector as described in relation to FIG. 2. However, it should be understood that the concepts of the invention herein are equally applicable for a wide variety of connector configurations, such as a connector which mounts socket terminals for receiving pin terminals of a complementary mating connector, for instance.

With those understandings, and still referring to FIG. 1, female or receptacle connector 12 includes a dielectric housing, generally designated 16, which includes a terminating face 18 and a mating face 20 in which receptacle 14 is disposed. The housing is a one-piece structure unitarily molded of plastic material or the like. As can be seen, housing 16 is elongated and receptacle 14 is defined by opposite elongated side walls 22 and narrow end walls 24. Therefore, receptacle 14 is considerably elongated, as shown. Side walls 22 are tapered outwardly, as at 25, at mating face 20 of the housing to define an outwardly flared mouth for receptacle 14.

As will be described in greater detail hereinafter, housing 16 mounts a plurality of connector terminals, generally designated 26. The terminals have contact portions 28 exposed on opposite sides of receptacle 14 and a plurality of tail portions 30 projecting out of the bottom of the housing, i.e., beyond terminating face 18. Connector 12 is designed for mounting on a printed circuit board and, therefore, terminating face 18 of housing 12 is a board-mounting face. Tail portions 30 of connector terminals 26 comprise solder tails for insertion into appropriate holes in the printed circuit board and for soldering to power circuit traces on the board and/or in the holes.

FIG. 2 shows an appropriate mating blade connector, generally designated 32, for mating with receptacle connector 12 of FIG. 1. The mating connecting device for receptacle connector 12 can take a variety of configurations. However, mating connector 32 is designed similar to receptacle connector 12. Suffice it to say, mating connector 32 includes a dielectric housing 34 which mounts a blade terminal 36. The terminating face of housing 34 and the terminating end of blade terminal 36 have been omitted because they can take a wide variety of configurations. The mating end of blade terminal 36 is tapered, as at 36a.

The mating blade connector 32 of FIG. 2 is mated with receptacle connector 12 of FIG. 1 by inserting the tapered end 36a of blade terminal 36 of the mating connector into receptacle 14 of the receptacle connector. The opposite faces of blade terminal 36 of the mating connector engage contact portions 28 of terminals 26 at opposite sides of receptacle 14 of the receptacle connector, thereby establishing a mating connector assembly through which power is transmitted, such as to the power circuit traces on the circuit board to which receptacle connector 12 is mounted. It can be seen that to form the electrical connector assembly, two distinct connectors, namely receptacle connector 12 and mating blade connector 32, are provided as a mating pair to establish the connector assembly.

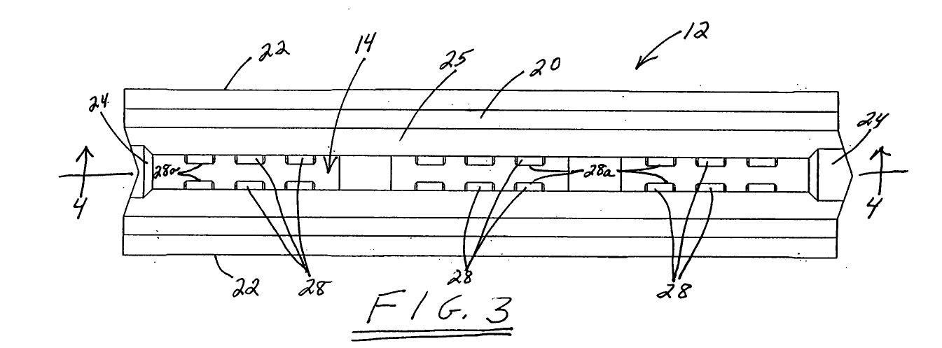

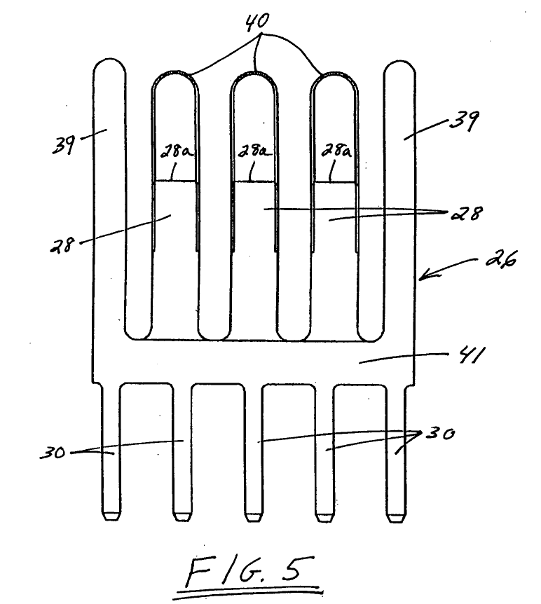

The invention contemplates converting receptacle connector 12 (FIG. 1) to a blade connector without in any way changing the receptacle connector. To that end, FIGS. 3-8 show details of the interior of receptacle connector 12.

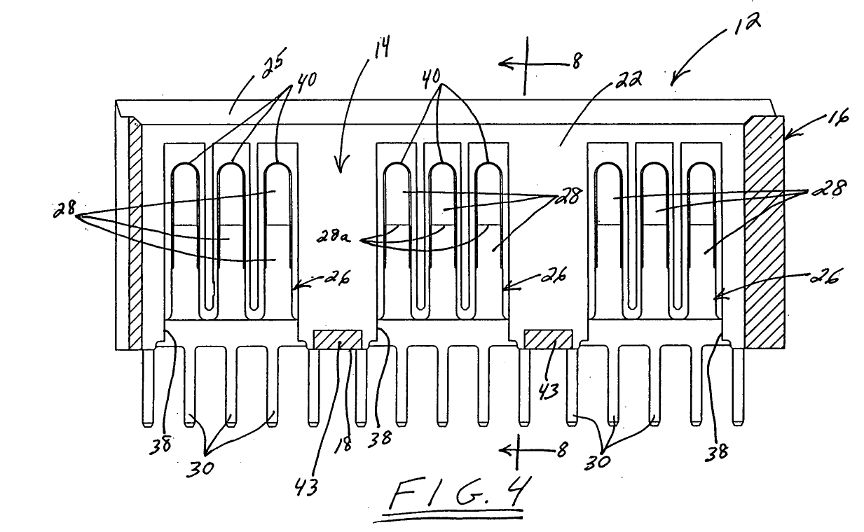

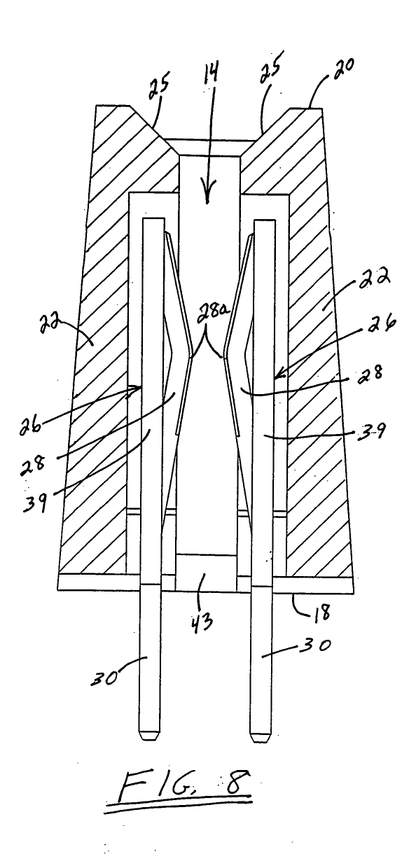

Specifically, FIG. 4 shows that there are three connector terminals 26 mounted in one side wall 22 of housing 16 and spaced longitudinally of receptacle 14. FIGS. 3 and 8 show that this array of three terminals are the same on opposite sides of receptacle 14.

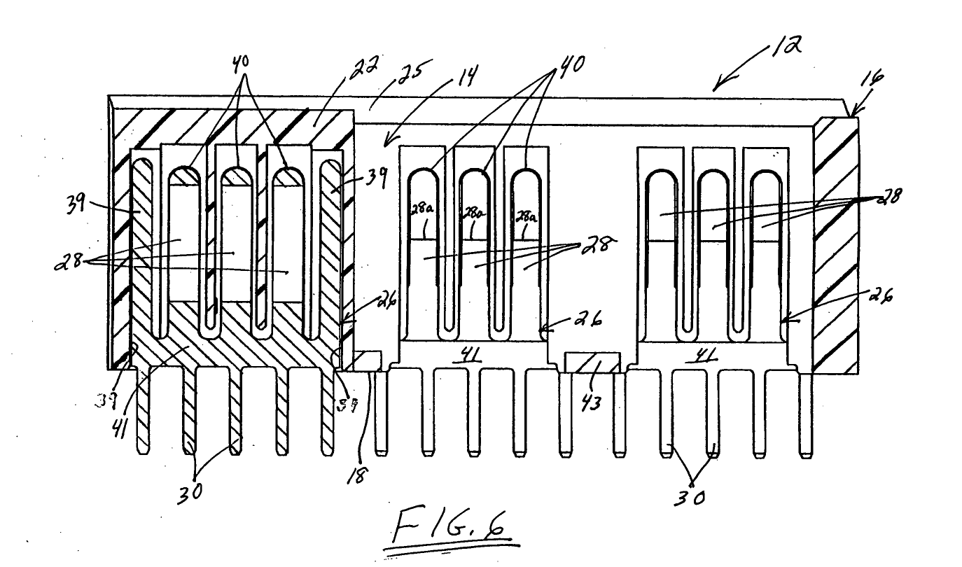

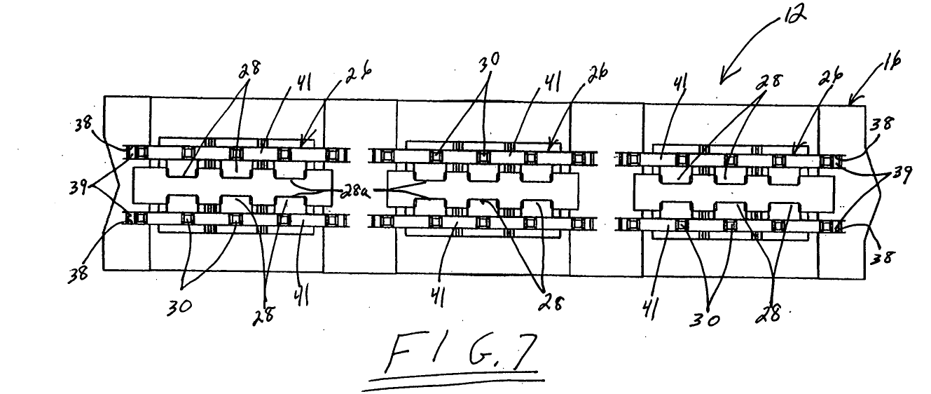

FIG. 6 shows that each terminal 26 is mounted within a respective board-mounting slot 38 in the inside face of a respective one of the side walls 22 of the housing. The terminals are press-fit into the slots at opposite ends by a pair of mounting arms 39. FIGS. 4-6 show that each connector terminal includes five solder tails 30 which project downwardly beyond board-mounting face 18 of the housing. Each connector terminal includes three upwardly projecting arms 40 out of which contact portions 28 are formed. Arms 39 and 40 project upwardly from a base 41, and solder tails 30 project downwardly from the base. The terminals may be stamped and formed of sheet metal material, and contact portions 28, thereby, are stamped and formed out of arms 40 to form three contact spring fingers 28. As seen in FIG. 8, the contact spring fingers 28 are bowed inwardly from opposite sides of receptacle 28, and as seen in both FIGS. 3 and 8, contact points 28a of the contact spring fingers project into receptacle 14 for engaging opposite sides of blade terminal 36 (FIG. 2) of the mating blade connector 32. FIG. 7 shows that the width of board-mounting slots 38 are slightly less than the width of mounting arms 39 to mount the terminals by a press fit.

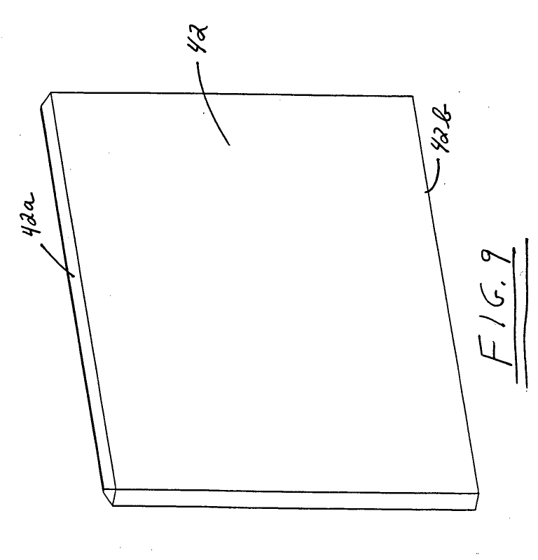

FIG. 9 shows a bare blade member 42 which, according to the invention, is used to convert receptacle connector (FIGS. 1 and 3-8) into a blade connector. Bare blade member 42 is a rectangular, flat structure having a tapered mating end 42a and a mounting end 42b.

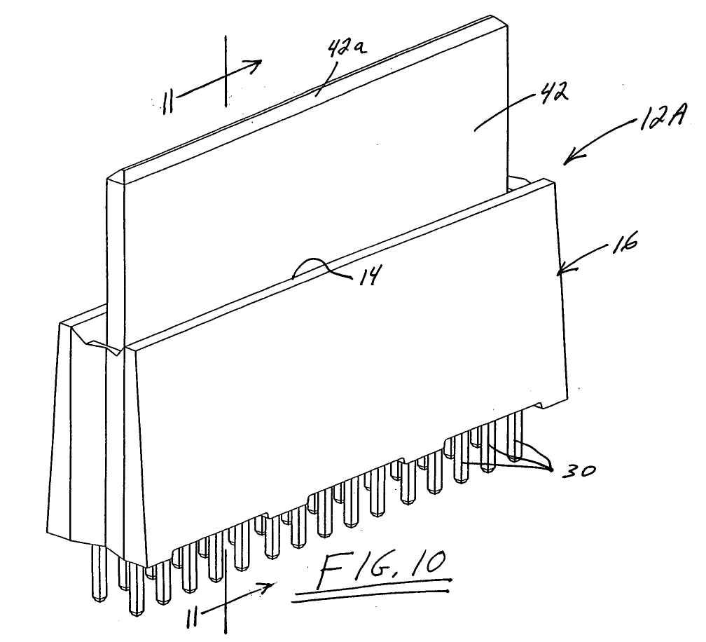

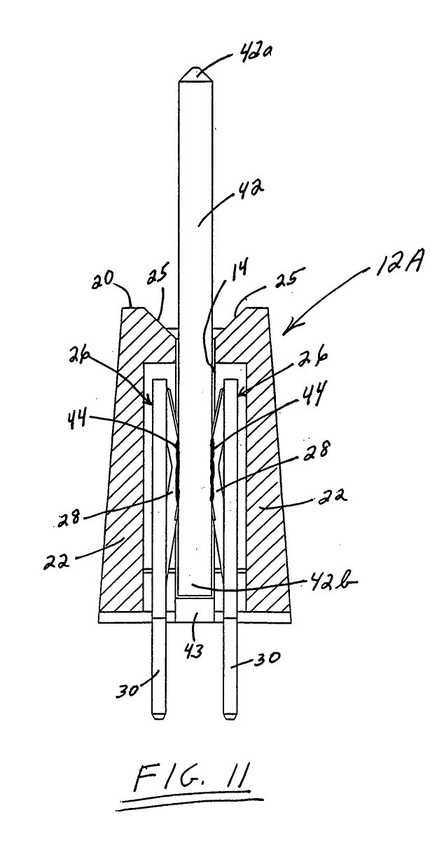

FIGS. 10 and 11 show bare blade member 42 inserted into receptacle 14 of receptacle connector 12 to convert the receptacle connector to a blade connector 12A. Mounting end 42b of the blade member is inserted into the receptacle all the way down until the mounting end of the blade member abuts against the top of bracing support portions 43 spanning the bottom of the receptacle. Approximately one-half of the bare blade member projects outwardly out of the receptacle to convert the receptacle connector to a blade connector, whereby the projecting portion of the bare blade member 42 can be inserted into a receptacle of a mating receptacle connector. The bare blade member engages all of the contact spring fingers 28 of connector terminals 26 and the contact spring fingers are permanently fixed to the blade terminal by solder fixation, as at 44 in FIG. 11. With bare blade member 42 fixed to terminals 26, receptacle connector 12 now has been permanently converted into a blade terminal 12A.

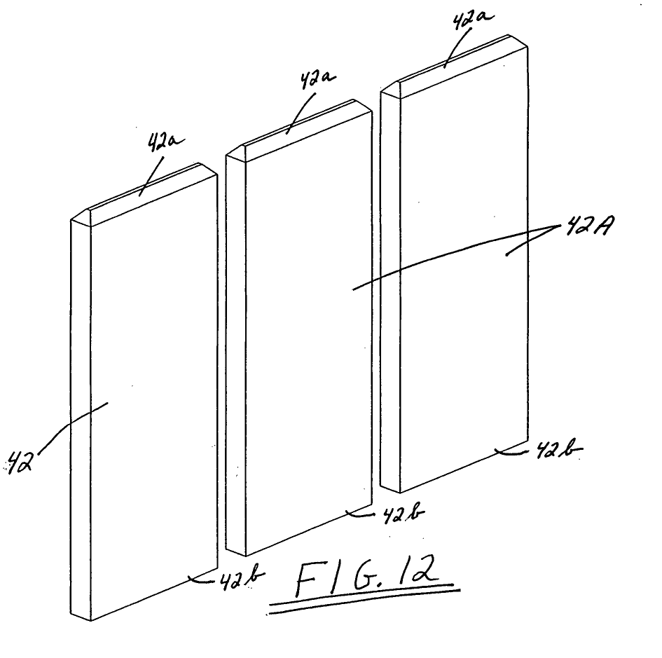

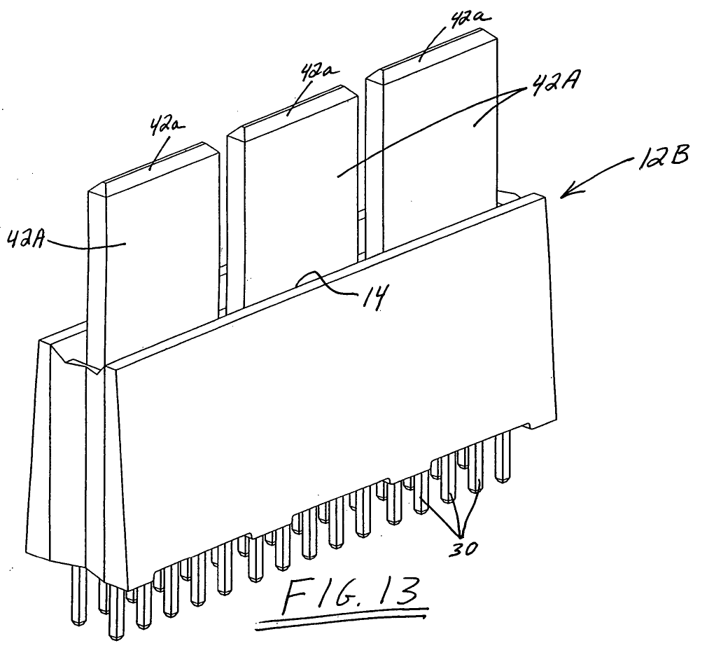

FIGS. 12 and 13 show an alternative embodiment of the invention wherein the bare blade member 42 of the embodiment of FIGS. 7 and 8 has been replaced by three distinct bare blade members 42A in FIGS. 9 and 10, to form a different configuration of a converted connector.

Specifically, as described above and shown in FIG. 4, there are three connector terminals 26 spaced along each opposite side of receptacle 14. Therefore, when the three bare blade members 42A are inserted into receptacle 14, each blade member 42A engages the contact spring fingers of only one of the connector terminals on each side of the receptacle. In other words, each bare blade member 42A engages two connector terminals 26 on opposite sides of the receptacle. Again, like the embodiment of FIGS. 10 and 11, bare blade members 42A are fixed, as by soldering, to the contact spring fingers 28 of the connector terminals.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An electrical connector capable of easy conversion from a receptacle connector to a blade connector, comprising:
a dielectric housing including a terminating face and a mating face which has an elongated receptacle for receiving a blade terminal of an appropriate mating blade connector;
at least one connector terminal mounted on the housing and including a contact portion exposed in the receptacle to form a receptacle connector and for engaging the blade terminal of the mating blade connector; and
a bare blade member having a mounting end fixable in said receptacle in engagement with the contact portion of the connector terminal, and a bare blade end projecting from the mating face of the housing to convert the receptacle connector to a blade connector.

2. The electrical connector of claim 1 wherein said contact portion of the connector terminal includes a plurality of contact spring fingers for engaging the blade terminal of the mating blade connector and, alternatively, for fixing to the bare blade member, as by soldering.

3. The electrical connector of claim 1 wherein said connector terminal includes a terminating portion exposed exteriorly of the housing.

4. The electrical connector of claim 3 wherein said terminating portion of the connector terminal comprises a plurality of tail portions for connection to appropriate circuit traces on a printed circuit board.

5. The electrical connector of claim 4 wherein said tail portions comprise solder tails for insertion into appropriate holes in the printed circuit board.

6. The electrical connector of claim 1, including a plurality of connector terminals mounted on the housing and each connector terminal includes a contact portion exposed in the receptacle for engaging the blade terminal of the mating blade connector and, alternatively, for fixing to said bare blade member.

7. The electrical connector of claim 6 wherein the contact portion of each connector terminal includes a plurality of contact spring fingers for engaging the blade terminal of the mating blade connector and, alternatively, for fixing to the bare blade member.

8. The electrical connector of claim 6 wherein said plurality of connector terminals are disposed on opposite sides of the receptacle.

9. The electrical connector of claim 8 wherein the contact portion of each connector terminal includes a plurality of contact spring fingers for engaging the blade terminal of the mating blade connector and, alternatively, for fixing to the bare blade member.

10. The electrical connector of claim 6 wherein said receptacle is elongated and said plurality of connector terminals are spaced longitudinally of the receptacle.

11. The electrical connector of claim 10 wherein the contact portion of each connector terminal includes a plurality of contact spring fingers for engaging the blade terminal of the mating blade connector and, alternatively, for fixing to the bare blade member.

12. The electrical connector of claim 10 wherein said plurality of connector terminals are spaced longitudinally along both opposite sides of the receptacle.

13. The electrical connector of claim 12 wherein the contact portion of each connector terminal includes a plurality of contact spring fingers for engaging the blade terminal of the mating blade connector and, alternatively, for fixing to the bare blade member.

14. The electrical connector of claim 10, including a plurality of said bare blade members fixable respectively to the connector terminals spaced longitudinally of the receptacle.

15. The electrical connector of claim 14 wherein the contact portion of each connector terminal includes a plurality of contact spring fingers for engaging the blade terminal of the mating blade connector and, alternatively, for fixing to the bare blade terminals.

16. An electrical connector capable of easy conversion from a receptacle connector to a blade connector, comprising:
a dielectric housing including a terminating face and a mating face which has an elongated receptacle for receiving a blade terminal of an appropriate mating blade connector;
at least one connector terminal mounted on the housing and including a contact portion which includes a plurality of contact spring fingers exposed in the receptacle to form a receptacle connector and for engaging the blade terminal of the mating blade connector, the connector terminal including a plurality of tail portions exposed exteriorly of the housing for connection to appropriate circuit traces on a printed circuit board; and
a bare blade member having a mounting end fixable in said receptacle in engagement with the contact spring fingers of the connector terminal, and a bare blade end projecting from the mating face of the housing to convert the receptacle connector to a blade connector.

17. The electrical connector of claim 16 wherein said tail portions comprise solder tails for insertion into appropriate holes in the printed circuit board.

18. The electrical connector of claim 16, including a plurality of connector terminals mounted on the housing and each connector terminal includes contact fingers exposed in the receptacle for engaging the blade terminal of the mating blade connector and, alternatively, for fixing to said bare blade member.

19. The electrical connector of claim 18 wherein said plurality of connector terminals are disposed on opposite sides of the receptacle.

20. The electrical connector of claim 18 wherein said receptacle is elongated and said plurality of connector terminals are spaced longitudinally of the receptacle.

21. The electrical connector of claim 20 wherein said plurality of connector terminals are spaced longitudinally along both opposite sides of the receptacle.

22. The electrical connector of claim 20, including a plurality of said bare blade members fixable respectively to the connector terminals spaced longitudinally of the receptacle.

23. An electrical connector capable of easy conversion from a female connector to a male connector, comprising:
a dielectric housing including a receptacle for receiving a male terminal of an appropriate mating male connector;
female terminal means mounted on the housing and including contact means exposed in the receptacle to form a female connector and for engaging the male terminal of the mating male connector; and
a male terminal member having a mounting end fixable in said receptacle in engagement with the contact means of the female terminal means, and a bare contact end projecting from the receptacle exteriorly of the housing to convert the female connector to a male connector.
